(19) United States
(12) Patent Application Publication
(10) Pub. No.: US 2026/0196435 A1
(43) Pub. Date: Jul. 9, 2026

(54) Passive device for protection of the electrical junction box of the LV power supply to a building from undesirable elevated temperature or flame burns.

(71) Applicant: MEGELLAN, SE, Praha 3 (CZ)

(72) Inventors: Marek Duda, Bohumin, Novy Bohumin (CZ); Peter Roncak, Roznov pod Radhostem (CZ)

(73) Assignee: MEGELLAN, SE, Praha 3 (CZ)

(21) Appl. No.: 18/860,803

(22) PCT Filed: May 30, 2023
(86) PCT No.: PCT/CZ2023/000020

§ 371 Date: Oct. 28, 2024

(30) Foreign Application Priority Data
Jun. 8, 2022 (CZ) PV 2022-246

(51) Int. Cl. H01H 85/02; A62C 3/16; A62C 37/11; H01H 85/044; H01H 85/06; H01H 85/20

(52) U.S. Cl. CPC H01H 85/0241; A62C 3/16; A62C 37/11; H01H 85/044; H01H 85/06; H01H 85/20; H01H 2085/2075

(57) ABSTRACT

A passive device for protection of the electrical junction box of a low voltage (LV) power supply to a building from undesirable elevated temperature or flame burns. The device includes a tank (5) with extinguishing medium, a plunger (6) that includes a seal for sealing the extinguishing medium in the extinguishing medium tank (5), a NC contact (4) attached to the upper part of the plunger (6) and made from electrically conductive material, a thermal fuse (7) attached to the upper part of the plunger (6), and a protective frame (8) arranged above the thermal fuse (7), wherein the passive device for protection of the electrical junction box is arranged in the first part (10.1) of a carrier (10), and in the second part (10.2) of the carrier (10) a fuse is arranged in the fuse base (1).

### FIELD OF THE INVENTION

The invention relates to a passive device for protection of the electrical junction box of the LV power supply to residential and industrial buildings from undesirable elevated temperature or flame burns. The electrical junction box for the supply of LV electricity to a residential building is referred to as the HDS (main building junction box), generally the term electrical junction box is used, this generic term will be used below.

### BACKGROUND OF THE INVENTION

In the existing electrical junction boxes, to which the LV electrical energy is supplied by cable or overhead lines for further distribution of this energy to the buildings, fuses are arranged to protect the electrical circuits in the buildings from short circuits or overloads. Each electrical phase has its own fuse, while blade fuses are used to protect more powerful circuits with three-phase circuits. Each fuse is arranged in a fuse base in the junction box.

The electrical junction boxes themselves, however, are not protected against undesirable rising temperatures, and very often undesirable temperature rises or even flame burns occur in electrical junction boxes due to overheating of cables, overheating of fuses, or ignition of dirt. Nowadays, electrical junction boxes are not protected against undesirable temperature rise or flame burns by disconnection from the main LV power supply connected by cable or overhead line.

### SUMMARY OF THE INVENTION

The above deficiency is eliminated by a passive device for protection of the electrical junction box for the supply of LV electricity to the building, from undesirable elevated temperature or flame burns, whose principle is that the passive device for protection of the electrical junction box from undesirable elevated temperature or flame burns is arranged in a first part of the carrier, and the fuse protecting the electrical circuits in the building against short circuit and overload is arranged in a second part of the carrier, in the fuse base, the first part of the carrier and the second part of the carrier forming a single compact unit.

At least one input contact is arranged at the end of the first part of the carrier for connection of LV power via the supply cable or overhead line for distribution to the building, or at least one branching contact is arranged here for branching the LV power supply to the adjacent electrical junction box. The power line from the input contact and the branching contact is routed separately to the point in the first part of the carrier where the passive device for protection of the electrical junction box is arranged, where the power line from the input contact and the branching contact is interrupted. After the interruption, the line continues from both contacts through at least one fuse, which protects the electrical circuits in the building from short circuit and overload, to at least one output contact.

The passive device for the protection of the electrical junction box comprises a tank containing the extinguishing medium, a plunger arranged in an opening in the upper part of the tank and extending inside the tank containing the extinguishing medium, and a seal for sealing the tank containing the extinguishing medium.

A NC contact made of electrically conductive material is attached to the upper end of the plunger and a thermal fuse is also attached to the upper end of the plunger, with the plunger, NC contact and thermal fuse assembly covered by a frame that is rigidly attached to the carrier.

In the fault-free condition, the plunger is inserted in the extinguishing medium tank, the NC contact is in the down position so that it connects the input contact, the branching contact and the contact of at least one fuse, protecting the electrical circuits in the building from short circuit and overload, to the output contact and into the building. The thermal fuse being arranged on the upper part of the plunger ensures that the plunger with the NC contact is in the down position.

### Failure Condition

The thermal fuse, arranged in the upper part of the plunger, is formed, for example, by a thermal glass ampule, which bursts when the temperature in the electrical junction box rises undesirably, releasing the plunger, which is inserted in the extinguishing medium tank, the plunger is pushed upwards together with the seal and the extinguishing medium escapes from the tank into the electrical junction box compartment, which cools down and decreases the undesirable elevated temperature or extinguishes the flame burning in the electrical junction box compartment. The NC contact, which is connected only to the upper part of the plunger, allowing it to move in the vertical plane simultaneously with the plunger movement, is lifted together with the plunger, thus disconnecting the line from the input and branching contact and the supply of LV power is interrupted. The thermal fuse is used here to interrupt the power line in case of increasing temperature in the protected environment.

The initiation temperature—of the protective device when the device starts to cool or extinguish—can be set by using different thermal fuses-glass ampules, each reacting by bursting at a different temperature in the environment to be protected. Such glass ampules are commercially available. In this design there is a new use of them, providing disconnection of the LV power supply in case of a fault, when the temperature rises or there is a flame burning in the electrical junction box.

In an preferred embodiment, the plunger is arranged together with a spring which causes the plunger to move upwards rapidly.

The described design is suitable for protection of electrical junction boxes for supply of LV power to a building, both single-phase and three-phase, and also with a branch of the main line to another building, whereby a carrier with a passive device for protection of the junction box against undesirable rising temperature, or flame burns, arranged in the first part of the carrier and a fuse against short circuit and overload, which is arranged in the fuse base, is arranged in each phase of the line.

The above described passive device for protection of the electrical junction box, for LV power supply to the building, from undesired elevated temperature or flame burns, which can occur in the electrical box by overheating of cables, ignition of dirt, because junction boxes are installed on buildings and dirt and dust can easily enter them. Temperatures in electrical junction boxes can also rise due to overheating of fuses that protect electrical circuits in the building from short circuits and overloads.

### BRIEF DESCRIPTION OF THE DRAWINGS

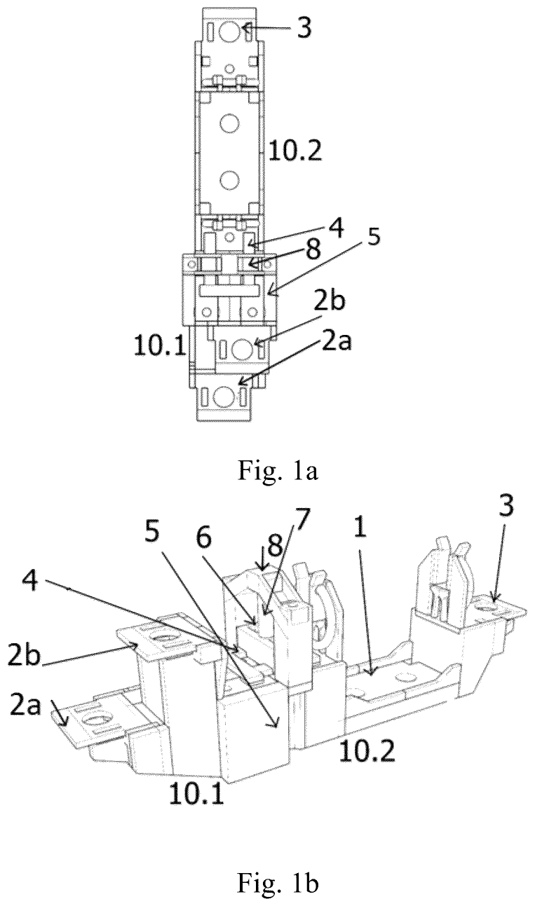

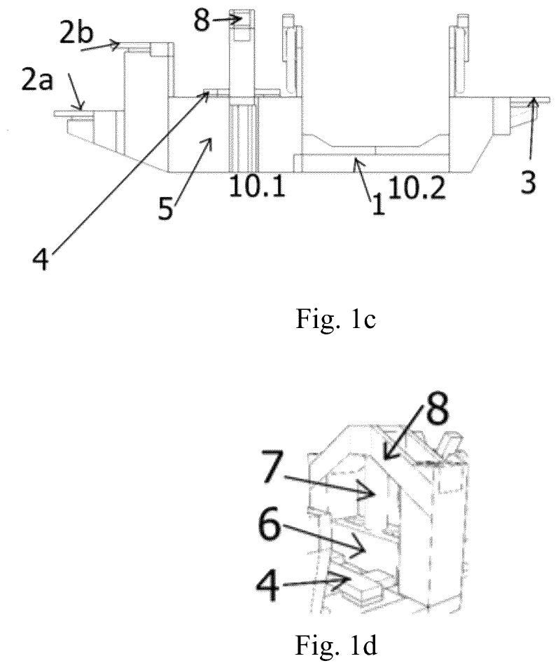

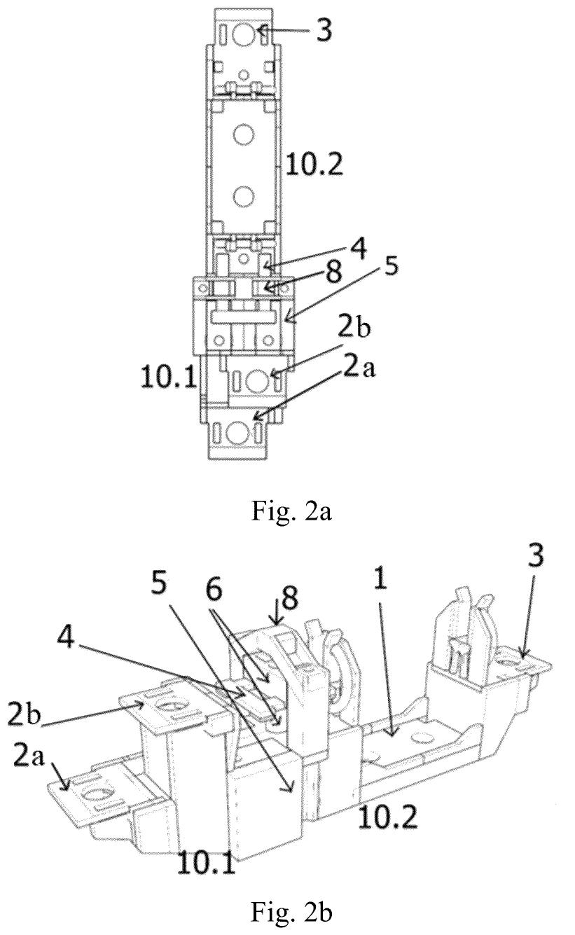

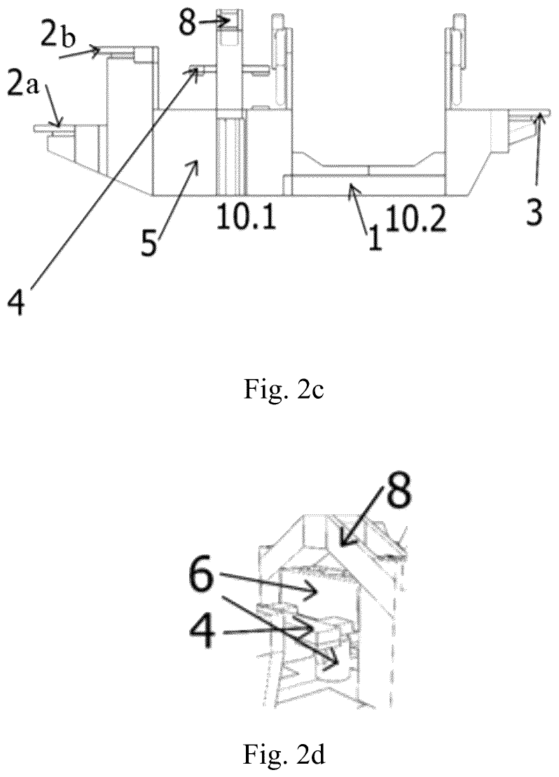

The invention will be further illustrated on the attached drawings, where FIG. 1 illustrates the condition without failure, while FIG. 1 a) shows the top view of the device for protection of the junction box, FIG. 1 b) shows the side view of the device, FIG. 1 c) shows a plan view of the device, and FIG. 1 d) shows plan view of the detail of the plunger and the NC contact, while FIG. 2 shows the failure condition, while FIG. 2 a) shows the top view of the device for protection of the junction box, FIG. 2 b) shows the side view of the device, FIG. 2 c) shows a plan view of the device, and FIG. 2 d) shows plan view of the detail of the plunger and the NC contact.

### EXAMPLES OF INVENTION EMBODIMENT

The specific embodiment of the invention, shown in FIG. 1 and FIG. 2 shows the design of protection of a electrical junction box for supply of LV power to building for one phase; it comprises one input contact 2a and one branching contact 2a for branching of electric power for the second junction box for another building.

The passive device for the protection of the electrical junction box against undesired elevated temperature or frame burns is arrange in the first part 10.1 of carrier 10, and the fuse protecting electrical circuits in the building against short circuit and overload is arranged in the second part 10.2 of carrier 10 in the fuse base 1, wherein the first part 10.1 of carrier 10 and the second part 10.2 of carrier 10 form a single compact unit.

The input contact 2a and the branching contact 2b are arranged at the end of the first part 10.1 of carrier 10, wherein an electrical line is routed from the input contact 2b and the NC contact 2a up to the point of the first part 10.1 of carrier 10, where the passive device for the protection of the electrical junction box is arranged, where the electrical line from the input contact 2a and branching contact 2b is interrupted, and after interruption the line continues from the input contact 2a through a fuse protecting the electrical circuits in the building against short circuit and overload up to the output contact 3.

The passive device for the protection of the electrical junction box comprises a tank 5 containing the extinguishing medium, a plunger 6 arranged in an opening in the upper part of the tank 5 and extending inside the tank 5 containing the extinguishing medium, the plunger 6 having a seal for sealing the extinguishing medium. A NC contact 4 is attached to the upper part of the plunger 6, made from electrically conductive material, and furthermore a thermal fuse 7 is attached to the upper part of the plunger 6. The plunger 6, NC contact 4 and thermal fuse 7 assembly is covered by a protective frame 8 that is rigidly attached to the carrier 10.

In the fault-free condition, the plunger 6 is inserted in the extinguishing medium tank, the NC contact 4 is in the down position so that it connects the interrupted line from the input contact 2a and the branching contact 2b, electricity flows through the fuse protecting the electrical circuits in the building from short circuit and overload, to the output contact 3 and into the building.

The thermal fuse 7 being arranged on the upper part of the plunger 6 ensures that the plunger 6 with the NC contact 4 is kept in the down position.

### Failure Condition

The thermal fuse 7, arranged in the upper part of the tank 5, is implemented as a thermal glass ampule, which is made so that it bursts at the undesired rising temperature of 50° C. in the electrical junction box, releasing the plunger 6, which is pushed upwards together with the seal and the extinguishing medium escapes from the tank into the electrical junction box compartment, which decreases the undesired elevated temperature or extinguishes the flame burn. The NC contact 4, which is connected only to the upper part of the plunger 6, allowing it to move in the vertical plane simultaneously with the movement of plunger 6, is lifted together with the plunger 6, thus disconnecting the line from the input contact 2a and branching contact 2b and the supply of LV power to the electrical junction box is interrupted. The disconnection persists until the passive protection device is replaced by a functional one.

### INDUSTRIAL APPLICABILITY

Passive device for protection of the electrical junction box of the LV power supply to a building from undesirable elevated temperature or flame burns can be used both in residential and industrial buildings. It can be used on the supply of one or three phases and also for the branching of the supply of LV electricity to an adjacent building. It can be used for electrical junction boxed on buildings and poles. Wherever there is a risk of undesirable temperature rise or flame burns in electrical junction boxes, the passive device is capable of cooling the rising temperature or extinguishing the flame burns.

1. A passive device for protection of electrical junction box of a low voltage (LV) power supply to a building from undesirable elevated temperature or flame burns, characterized by
a tank (5) with extinguishing medium,
a plunger (6) arranged in an opening in an upper part of the tank (5) and immersed in the tank (5), wherein the plunger (6) includes a seal for sealing the extinguishing medium in the tank (5),
a NC contact (4) is attached to the upper part of the plunger (6) and made from electrically conductive material,
a thermal fuse (7) attached to the upper part of the plunger (6), and
a protective frame (8) arranged above the thermal fuse (7) and rigidly attached to a carrier (10),
wherein the passive device for protection of the electrical junction box is arranged in the first part (10.1) of the carrier (10), and in the second part (10.2) of the carrier (10) a fuse is arranged in the fuse base (1) for protecting the electrical circuits in the building against short circuit and overload,
wherein the first part (10.1) of the carrier (10) and the second part (10. 2) of the carrier (10) form single compact unit,
wherein at least one supply contact (2a) and at least one branching contact (2b) are arranged at an end of the first part (10.1) of the carrier (10) and an output contact (3) is arranged at an end of the second part (10.2) of the carrier (10).

2. The device according to claim 1, characterized in that the thermal fuse (7) is implemented as thermal glass ampule to burst at increased undesired temperature or during flame burning in the electrical junction box for disconnecting the cable or external LV power supply to the electrical junction box.

3. The device according to claim 1, characterized in that the plunger (6) is arranged together with a spring.

4. The device according to claim 2, characterized in that the plunger (6) is arranged together with a spring.
